(19) United States
(12) Patent Application Publication
(10) Pub. No.: US 2014/0041444 A1
(43) Pub. Date: Feb. 13, 2014

(54) APPARATUS FOR ANTENNA WEIGHTLESSNESS DEPLOYMENT TEST

(71) Applicant: ELECTRONICS AND TELECOMMUNICATIONS, Daejeon (KR)

(72) Inventors: Jang Sup CHOI, Daejeon (KR); Chang Soo KWAK, Daejeon (KR); In Bok YOM, Daejeon (KR); Man Seok UHM, Daejeon (KR); Hong Yeol LEE, Chungcheongbuk-do (KR); So Hyeun YUN, Daejeon (KR)

(73) Assignee: ELECTRONICS AND TELECOMMUNICATIONS RESEARCH INSTITUTE, Daejeon (KR)

(21) Appl. No.: 13/658,192

(22) Filed: Oct. 23, 2012

(30) Foreign Application Priority Data
Aug. 9, 2012 (KR) 10-2012-0087295

(51) Int. Cl. G01M 1/00

(52) U.S. Cl. 73/118.01

(57) ABSTRACT

Disclosed is an apparatus for an antenna weightlessness deployment test. The apparatus for an antenna weightlessness deployment test includes: a pair of first direction mobile support shafts mounted in parallel at a predetermined distance; first direction mobile deployment apparatuses mounted to be supported by an air bearing so as to slidably move on the first direction mobile support shaft; a second direction mobile support shaft mounted to connect the first direction mobile deployment apparatuses with each other; and second direction mobile deployment apparatuses mounted to be supported by an air bearing so as to slidably move on the second direction mobile support shaft.

### CROSS-REFERENCE TO RELATED APPLICATIONS

This application claims priority to and the benefit of Korean Patent Application No. 10-2012-0087295 filed in the Korean Intellectual Property Office on Aug. 9, 2012, the entire contents of which are incorporated herein by reference.

### TECHNICAL FIELD

The present invention relates to an apparatus for an antenna weightlessness deployment test, and more particularly, to an apparatus for an antenna weightlessness deployment test in which a first direction mobile deployment apparatus and a second direction mobile deployment apparatus are each configured to be supported on a first direction mobile support shaft and a second direction mobile support shaft by an air bearing, and the first direction mobile deployment apparatus and the second direction mobile deployment apparatus are configured to be disposed at both ends of each of the first direction mobile support shaft and the second direction mobile support shaft so as to stop at a predetermined position using an air pressure at the time of operating the first direction mobile deployment apparatus and the second direction mobile deployment apparatus.

### BACKGROUND ART

An antenna reflector to be mounted in a satellite is fixed to a satellite vehicle in a folded state so as to be mounted in a limited space of projectile paring at the time of a satellite launch and is deployed at a predetermined angle so as to radiate radio waves to the earth after a fixture is released by an electrical exploding apparatus under the weightlessness space environment after being launched.

In this case, since a load applied to the deployed reflector is in a weightlessness state unlike the ground, the reflector can easily be deployed only by a very small driving torque. The antenna deployment test is performed in a satellite assembly building before the satellite is launched so as to determine whether the antenna is properly deployed in the space. To this end, a need exists for an apparatus for simulating the weightlessness environment similar to that of the space.

A weightlessness simulating apparatus for testing the deployment of the satellite antenna uses a balloon type and a girder type.

The balloon type is a method that injects light gas, that is, He into a balloon having an appropriate size to generate buoyancy and offsets a gravity effect applied to the reflector by the buoyancy of the balloon when the balloon is hung to a center of weight of the antenna reflector and the antenna is deployed However, there is a need for an opened space in which a building ceiling is considerably high so as to hang the balloon, and there are several restrictions such as stopping an operation of an air conditioner so as to prevent the balloon from being swayed due to the flow of air during the deployment test.

The girder type is a weightlessness simulating apparatus in a form in which a metal frame having an appropriate size is mounted a space in which the reflector is deployed, and a driver having a horizontally or vertically movable pulley (or, a contact type bearing apparatus) so as to follow up a deployed trajectory of the reflector is mounted in the top portion of the metal frame and is connected with the reflector by a wire. Generally, the reflector is connected with the driver by a load cell to check whether the load compensation is appropriately made, and a tension can be controlled by a spring and the like, such that the reflector is designed so as to constantly apply the compensation load thereto at all times.

However, the type is operated by the pulley, the contact type bearing, and the like, such that some friction force cannot be avoided. Therefore, the type is not completely free when the driver follows up the deployed trajectory of the reflector. There is some overshooting on the trajectory so as to stop the reflector even after the deployment of the reflector ends due to the inertia generated by the weight of the driver.

Therefore, the deployment test of the reflector may be incomplete or a risk of applying an unreasonable load to a very precise and sensitive reflector deployment driving apparatus that is attached to the satellite may reside.

As described above, when using the existing balloon type, the opened space having the considerably high ceiling is required or when using the girder type, it is difficult to follow up the deployed trajectory of the reflector in the weightlessness state like the space due to the friction force of the driving apparatus.

### SUMMARY OF THE INVENTION

The present invention has been made in an effort to provide an apparatus for antenna weightlessness deployment test configured so that a first direction mobile deployment apparatus and a second direction mobile deployment apparatus are each supported on a first direction mobile support shaft and a second direction mobile support shaft by an air bearing.

The present invention also has been made in an effort to provide an apparatus for antenna weightlessness deployment test configured so as to be disposed at both ends of each of the first direction mobile support shaft and the second direction mobile support shaft so that a first direction mobile deployment apparatus and a second direction mobile deployment apparatus stop at a predetermined position using an air pressure at the time of operating the first direction mobile deployment apparatus and the second direction mobile deployment apparatus. However, objects of the present invention are not limited to the above-mentioned matters and other objects not described can be clearly understood to those skilled in the art from the following descriptions.

An exemplary embodiment of the present invention provides an apparatus for an antenna weightlessness deployment test, including: a pair of first direction mobile support shafts mounted in parallel at a predetermined distance; first direction mobile deployment apparatuses mounted to be supported by an air bearing so as to slidably move on the first direction mobile support shaft; a second direction mobile support shaft mounted to connect the first direction mobile deployment apparatuses with each other; and second direction mobile deployment apparatuses mounted to be supported by an air bearing so as to slidably move on the second direction mobile support shaft.

The first direction mobile deployment apparatus may include a compressed air inlet formed to enclose the first direction mobile support shaft and configured to inject compressed air.

The second direction mobile deployment apparatus may include a compressed air inlet formed to enclose the second direction mobile support shaft and configured to inject compressed air.

The apparatus for an antenna weightlessness deployment test may further include: first direction overshooting preventing apparatuses mounted at one end of the first direction mobile support shaft to stop the first direction mobile deployment apparatus slidablty moving on the first direction mobile support shaft due to an inertial force generated by a mass of the first direction mobile deployment apparatus at a predetermined point using high-pressure air.

The first direction overshooting preventing apparatuses may be at a predetermined distance at a predetermined point at a predetermined distance and the predetermined distance may be changed according to the inertial force and the pressure of the high-pressure air. The first direction overshooting preventing apparatus may include: a carriage body configured to discharge the high-pressure air between the first direction mobile deployment apparatuse and the first direction overshooting preventing apparatus; a carriage spring compressed when the carriage body is pushed due to the high-pressure air according to the movement of the first direction mobile deployment apparatus; and a fixture connected to one side of the carriage spring so as to be fixed to one end of the first direction mobile support shaft.

The carriage body may be formed to enclose the first direction mobile support shaft and mounted to be supported by an air bearing so as to slidably move on the first direction mobile support shaft.

The apparatus for an antenna weightlessness deployment test may further include: a second direction overshooting preventing apparatus mounted at one end of the second direction mobile support shaft to stop the second direction mobile deployment apparatus slidably moving on the second direction mobile support shaft due to an inertial force generated by a mass of the second direction mobile deployment apparatus at a predetermined point using high-pressure air.

The first direction overshooting preventing apparatuses may be mounted at the predetermined point at a predetermined distance and the predetermined distance may be changed according to the inertial force and the pressure of the high-pressure air.

The second direction overshooting preventing apparatus may include: a carriage body configured to discharge the high-pressure air between the second direction mobile deployment apparatuse and the second direction overshooting preventing apparatus; a carriage spring compressed when the carriage body is pushed due to the high-pressure air according to the movement of the second direction mobile deployment apparatus; and a fixture connected to one side of the carriage spring so as to be fixed to one end of the second direction mobile support shaft.

The carriage body may be formed to enclose the second direction mobile support shaft and mounted to be supported by an air bearing so as to slidably move on the first direction mobile support shaft.

According to the exemplary embodiments of the present invention, it is possible to surprisingly reduce the driving friction force by supporting each of the first direction mobile deployment apparatus and the second direction mobile deployment apparatus on the first direction mobile support shaft and the second direction mobile support shaft by the air bearing so as to slide on the air layer without directly contacting the metal surface.

According to the exemplary embodiments of the present invention, it is possible to smoothly stop the deployment apparatuses without overshooting on the trajectory due to the inertial force by disposing the first direction mobile deployment apparatus and the second direction mobile deployment apparatus at both ends of each of the first direction mobile support shaft and the second direction mobile support shaft so that the deployment apparatuses stop at a predetermined position using the air pressure at the time of operating the deployment apparatuses.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a plan view of an apparatus for a weightlessness deployment test according to an exemplary embodiment of the present invention.

FIG. 2 is a front view of an apparatus for a weightlessness deployment test according to an exemplary embodiment of the present invention.

FIG. 3 is a diagram showing a detailed configuration of an overshooting preventing apparatus according to an exemplary embodiment of the present invention.

FIG. 4 is a diagram for describing an operating principle of the overshooting preventing apparatus according to an exemplary embodiment of the present invention.

FIG. 5 is a side view of the apparatus for a weightlessness deployment test according to an exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

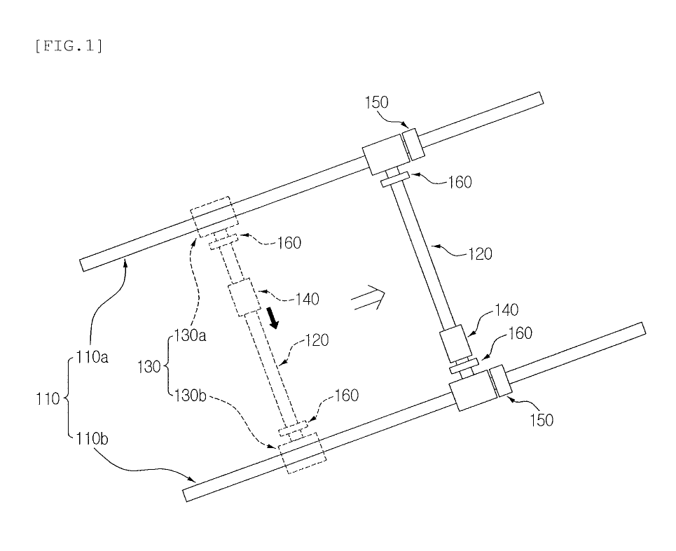

Hereinafter, an apparatus for an antenna weightlessness deployment test according to an exemplary embodiment of the present invention will be described with reference to FIGS. 1 to 5. Exemplary embodiments of the present invention will be described in detail based on portions necessary to understand the operations and actions of the present invention.

In particular, the present invention proposes a new apparatus configured to be disposed at both ends of each of a first direction mobile support shaft and a second direction mobile support shaft so that a first direction mobile deployment apparatus and a second direction mobile deployment apparatus, respectively, are supported on a first direction mobile support shaft and a second direction mobile support shaft by an air bearing and stop at a predetermined position using an air pressure at the time of operating the first direction mobile deployment apparatus and the second direction mobile deployment apparatus. Herein, the first direction may represent a horizontal direction and the second direction may represent a vertical direction, while the first direction may represent a vertical direction and the second direction may represent a horizontal direction.

FIG. 1 is a plan view of an apparatus for a weightlessness deployment test according to an exemplary embodiment of the present invention.

As shown in FIG. 1, an apparatus for a weightlessness deployment test according to an exemplary embodiment of the present invention is disposed on the top at the time of a deployment test of an antenna reflector or a solar cell plate included in a satellite and may include first direction mobile support shafts 110, second direction mobile support shafts 120, first direction mobile deployment apparatuses 130, second direction mobile deployment apparatuses 140, first direction overshooting preventing apparatuses 150, second direction overshooting preventing apparatuses 160, and the like.

The first direction mobile support shaft 110 is configured of a pair of bars, which may be disposed in parallel at a predetermined distance. That is, the first direction mobile support shaft 110 is configured of a pair of a 1-1-th direction mobile support shaft 110a and a 2-1-th direction mobile support shaft 110b.

The second direction mobile support shafts 120 may be mounted on each of a pair of the first direction mobile support shafts 110 to connect slidably moved first direction mobile deployment apparatuses 130 with each other. The first direction mobile deployment apparatuses 130 may be formed to enclose the first direction mobile support shafts 100 and may be mounted on each of the pair of first direction mobile support shafts 110 so as to slidably move along the first direction mobile support shafts 110. That is, in the first direction mobile deployment apparatus 130, a pair of the 1-1-th direction mobile deployment apparatus 130a and a 2-1-th direction mobile deployment apparatus 130b slidably moves while being connected all in one.

In this configuration, the first direction mobile deployment apparatus 130 is formed so as to be supported on the first direction mobile support shaft 110 by an air bearing using compressed air.

The second direction mobile deployment apparatus 140 may be formed to enclose the second direction mobile support shaft 120 and may be mounted on the second direction mobile support shaft 120 so as to slidably move along the second direction mobile support shaft 120. In this case, the second direction mobile deployment apparatus 140 is formed to be supported on the second direction mobile support shaft 120 by the air bearing using the compressed air, likewise the first direction.

As such, the first direction mobile deployment apparatus 130 and the second direction mobile deployment apparatus 140 are formed so as to be supported by the air bearing using the compressed air and therefore, may be freely followed up in the state in which a friction force is more remarkably reduced than that of the existing contact type bearing.

The antenna reflector or the solar cell plate connected to the second direction mobile deployment apparatus 140 is deployed according to the movement of the first direction mobile deployment apparatus 130 and the second direction mobile deployment apparatus 140.

The first direction overshooting preventing apparatus 150 may serve to prevent overshooting when the deployment ends due to the inertial force generated by the mass of the first direction mobile deployment apparatus 130. The first direction overshooting preventing apparatus 150 is mounted at one end of the first direction mobile support shaft 110 and may be mounted by reflecting a length of the antenna reflector when the deployment of the antenna reflector ends.

The second direction overshooting preventing apparatus 160 may serve to prevent overshooting when the deployment ends due to the inertial force generated by the mass of the second direction mobile deployment apparatus 140. The second direction overshooting preventing apparatus 160 may be mounted at both ends of the second direction mobile support shaft 120.

In the drawing, the first direction mobile deployment apparatus 130 moves from the left to the right of the first direction mobile support shaft 110 according to the deployment of the antenna reflector, and the second direction mobile deployment apparatus 140 moves downwardly from the middle of the second direction mobile support shaft 120.

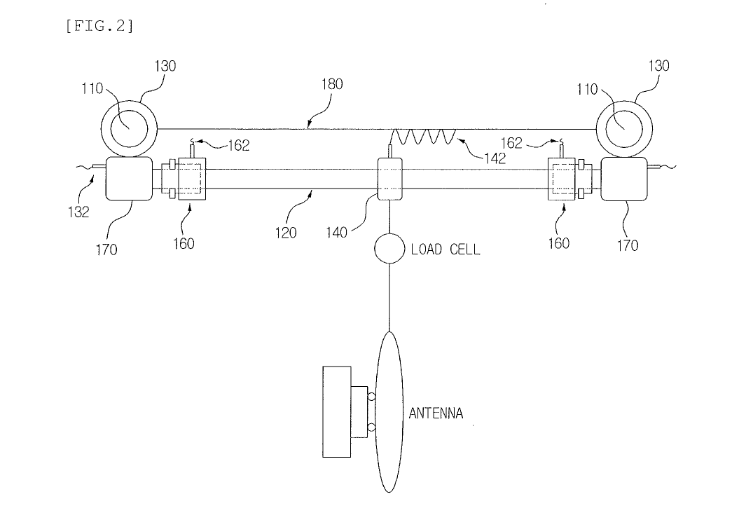

FIG. 2 is a front view of an apparatus for a weightlessness deployment test according to an exemplary embodiment of the present invention.

FIG. 2 shows the second direction mobile deployment apparatus 140 slidably moving on the second direction mobile support shaft 120 within the apparatus for a weightlessness deployment test according to the exemplary embodiment of the present invention.

The first direction mobile deployment apparatus 130 is supported on the first direction mobile support shaft 110 by the air bearing, and the first direction mobile deployment apparatus 130 is connected with the second direction mobile support shaft 120 by a connection frame 170 and thus, the second direction mobile support shaft 120 moves together according to the movement of the first direction mobile deployment apparatus 130.

In this case, the first direction mobile deployment apparatus 130 and the second direction mobile support shaft 120 are not necessarily connected by the connection frame 170 and therefore, may be directly connected with each other, if necessary.

The first direction mobile deployment apparatus 130 is supported on the first direction mobile support shaft 110 by the air bearing, by injecting the compressed air through a compressed air inlet provided at one side of the connection frame 170 and using the injected compressed air.

In this case, the compressed air inlet is provided at one side of the connection frame 170, but is not necessarily limited thereto. Therefore, it is apparent that the inlet may be provided at any position for forming the air bearing.

The second direction mobile deployment apparatus 140 is mounted on the second direction mobile support shaft 120.

In this case, the second direction mobile deployment apparatus 140 is supported on the second direction mobile support shaft 120 by the air bearing, by injecting the compressed air through the compressed air inlet and using the injected compressed air.

The second direction overshooting preventing apparatus 160, that is, the first and a 1-2-th direction overshooting preventing apparatus 160a and a 2-2-th direction overshooting preventing apparatus 160b for preventing the second direction mobile deployment apparatus 140 from overshooting are each mounted at both ends of the second direction mobile support shaft 120.

A load cell and an antenna for checking whether load compensation is appropriately made are connected with the second direction mobile deployment apparatus 140 by a wire or a cable.

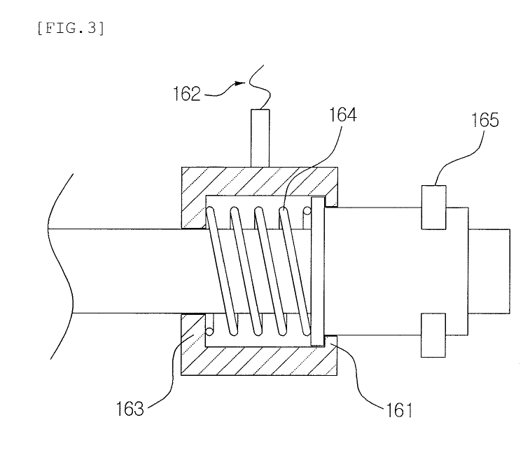

FIG. 3 is a diagram showing a detailed configuration of the overshooting preventing apparatus according to an exemplary embodiment of the present invention.

FIG. 3 shows an example of the second direction overshooting preventing apparatus 160 according to the exemplary embodiment of the present invention, and the structure of the second direction overshooting preventing apparatus 160 may be similarly applied to the first direction overshooting preventing apparatus.

The second direction overshooting preventing apparatus 160 may include a carriage body 161, a compressed air inlet 162, a high-pressure air outlet 163, a carriage spring 164, a fixture 165, and the like.

The carriage body 161 injects the compressed air through the compressed air inlet 162 and discharges the high-pressure air through the high-pressure air outlet 163. The carriage body 161 discharges the high-pressure air having a constant pressure to hold a predetermined carriage action distance from the second direction mobile deployment apparatus 130 slidably moved due to the inertial force generated by the mass of the second direction mobile deployment apparatus 130.

In this case, the predetermined carriage action distance may be changed according to the inertial force and the pressure of the high-pressure air.

The carriage spring 164 may be compressed together when the carriage body 161 is pushed according to the movement of the second direction mobile deployment apparatus 130. Then, the carriage spring 164 may be recovered when the second direction mobile deployment apparatus 130 moves in an opposite direction.

In this case, the carriage spring 164 uses the spring having the predetermined elastic force.

The fixture 165 is mounted so as to be fixed to a predetermined point of the second direction mobile support shaft 120 to prevent the carriage body 161 from being continuously pushed.

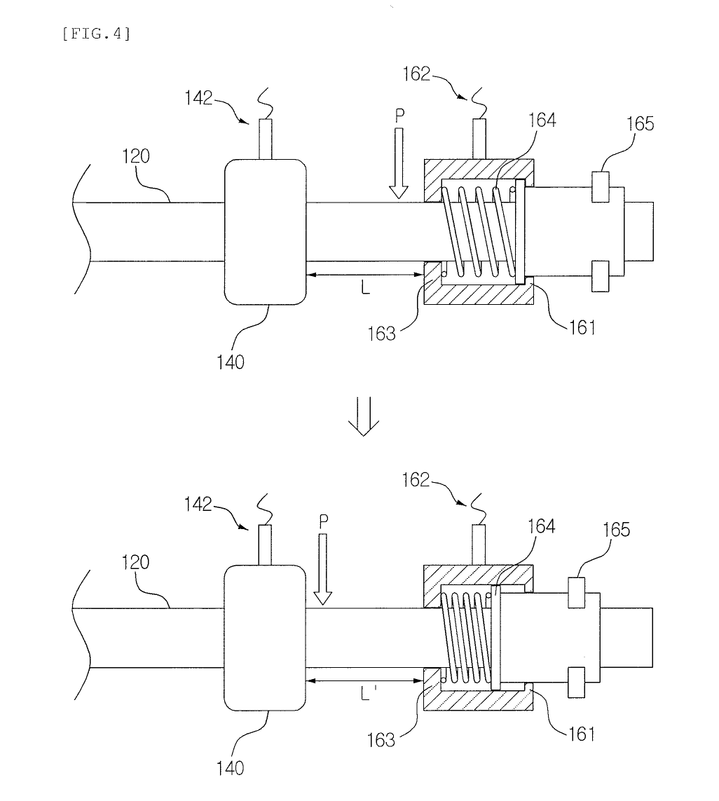

FIG. 4 is a diagram for describing an operating principle of the overshooting preventing apparatus according to the exemplary embodiment of the present invention.

FIG. 4 shows the operating principle of the second direction overshooting preventing apparatus according to an operation of the second direction mobile deployment apparatus on the second direction mobile support shaft. The second direction overshooting preventing apparatus 160 injects the compressed air through the compressed air inlet 162 before the deployment of the antenna reflector starts and discharges the high-pressure air through the high-pressure air outlet 163. The predetermined carriage action distance L is secured between the second direction mobile deployment apparatus 140 and the second direction overshooting preventing apparatus 160 by the high-pressure air.

The second direction mobile deployment apparatus 140 slidably moves to the right on the second direction mobile support shaft 120, that is, the second direction overshooting preventing apparatus 160 according to the deployment of the antenna reflector.

When the distance between the second direction mobile deployment apparatus 140 and the second direction overshooting preventing apparatus 160 becomes the predetermined carriage action distance according to the movement of the second direction mobile deployment apparatus 140, the carriage body 161 of the second direction overshooting preventing apparatus 160 is pushed and therefore, the carriage spring 164 is compressed together.

The second direction mobile deployment apparatus 140 moves and then, stops at a deployment ending point P that is a predetermined point. In this case, the spaced distance L′ smaller than the predetermined carriage action distance is continuously maintained between the second direction mobile deployment apparatus 140 and the second direction overshooting preventing apparatus 160.

That is, the second direction overshooting preventing apparatus 160 according to the exemplary embodiment of the present invention is pushed while maintaining the spaced distance to some degree without directly colliding due to the air pressure according to the movement of the second direction mobile deployment apparatus 140.

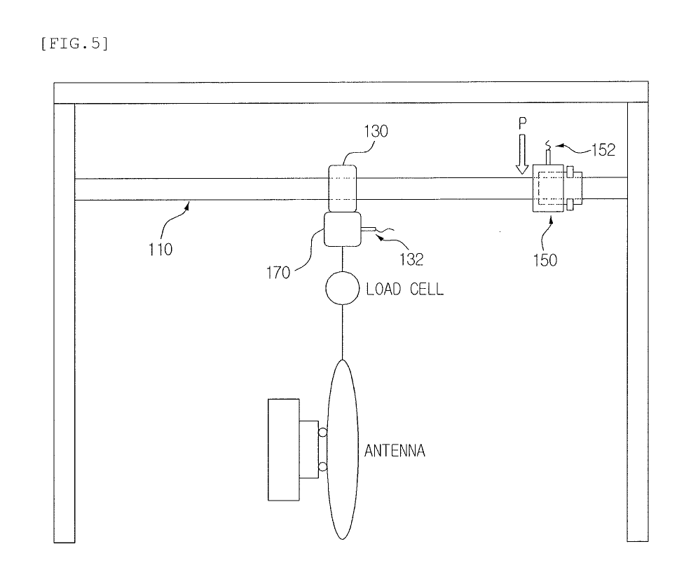

FIG. 5 is a side view of the apparatus for a weightlessness deployment test according to the exemplary embodiment of the present invention.

FIG. 5 shows the horizontal mobile deployment apparatus 130 slidably moving on the first direction mobile support shaft 110 within a girder structure of the apparatus for a weightlessness deployment test according to the exemplary embodiment of the present invention.

In this case, the first direction mobile deployment apparatus 130 is supported on the first direction mobile support shaft 110 by the air bearing, by injecting the compressed air through the compressed air inlet and using the injected compressed air.

The first direction overshooting preventing apparatus 150 for preventing the overshooting of the first direction mobile deployment apparatus 130 is mounted at the end of the first direction mobile support shaft 110.

In this case, the operating principle of the first direction overshooting preventing apparatus 150 is the same as the operating principle of the vertical overshooting preventing apparatus 160 described in FIG. 4 and therefore, the description thereof will be omitted below.

The second direction mobile deployment apparatus (not shown) at the rear portion of the first direction mobile deployment apparatus 130 is connected with the load cell and the antenna by the wire.

Meanwhile, the embodiments according to the present invention may be implemented in the form of program instructions that can be executed by computers, and may be recorded in computer readable media. The computer readable media may include program instructions, a data file, a data structure, or a combination thereof. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

As described above, the exemplary embodiments have been described and illustrated in the drawings and the specification. The exemplary embodiments were chosen and described in order to explain certain principles of the invention and their practical application, to thereby enable others skilled in the art to make and utilize various exemplary embodiments of the present invention, as well as various alternatives and modifications thereof. As is evident from the foregoing description, certain aspects of the present invention are not limited by the particular details of the examples illustrated herein, and it is therefore contemplated that other modifications and applications, or equivalents thereof, will occur to those skilled in the art. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. An apparatus for an antenna weightlessness deployment test, comprising:
a pair of first direction mobile support shafts mounted in parallel at a predetermined distance;
first direction mobile deployment apparatuses mounted to be supported by an air bearing so as to slidably move on the first direction mobile support shaft;
a second direction mobile support shaft mounted to connect the first direction mobile deployment apparatuses with each other; and
second direction mobile deployment apparatuses mounted to be supported by an air bearing so as to slidably move on the second direction mobile support shaft.

2. The apparatus of claim 1, wherein the first direction mobile deployment apparatus includes a compressed air inlet formed to enclose the first direction mobile support shaft and configured to inject compressed air.

3. The apparatus of claim 1, wherein the second direction mobile deployment apparatus includes a compressed air inlet formed to enclose the second direction mobile support shaft and configured to inject compressed air.

4. The apparatus of claim 1, further comprising:
first direction overshooting preventing apparatuses mounted at one end of the first direction mobile support shaft to stop the first direction mobile deployment apparatus slidably moving on the first direction mobile support shaft due to an inertial force generated by a mass of the first direction mobile deployment apparatus at a predetermined point using high-pressure air.

5. The apparatus of claim 4, wherein the first direction overshooting preventing apparatuses are at a predetermined distance at a predetermined point and the predetermined distance is changed according to the inertial force and the pressure of the high-pressure air.

6. The apparatus of claim 4, wherein the first direction overshooting preventing apparatus includes:
a carriage body configured to discharge the high-pressure air between the first direction mobile deployment apparatuses and the first direction overshooting preventing apparatus;
a carriage spring compressed when the carriage body is pushed due to the high-pressure air according to the movement of the first direction mobile deployment apparatus; and
a fixture connected to one side of the carriage spring so as to be fixed to one end of the first direction mobile support shaft.

7. The apparatus of claim 6, wherein the carriage body is formed to enclose the first direction mobile support shaft and mounted to be supported by an air bearing so as to slidably move on the first direction mobile support shaft.

8. The apparatus of claim 1, further comprising:
a second direction overshooting preventing apparatus mounted at one end of the second direction mobile support shaft to stop the second direction mobile deployment apparatus slidably moving on the second direction mobile support shaft due to an inertial force generated by a mass of the second direction mobile deployment apparatus at a predetermined point using high-pressure air.

9. The apparatus of claim 8, wherein the first direction overshooting preventing apparatuses are mounted at the predetermined point at a predetermined distance and the predetermined distance is changed according to the inertial force and the pressure of the high-pressure air.

10. The apparatus of claim 8, wherein the second direction overshooting preventing apparatus includes:
a carriage body configured to discharge the high-pressure air between the second direction mobile deployment apparatus and the second direction overshooting preventing apparatus;
a carriage spring compressed when the carriage body is pushed due to the high-pressure air according to the movement of the second direction mobile deployment apparatus; and
a fixture connected to one side of the carriage spring so as to be fixed to one end of the second direction mobile support shaft.

11. The apparatus of claim 10, wherein the carriage body is formed to enclose the second direction mobile support shaft and mounted to be supported by an air bearing so as to slidably move on the first direction mobile support shaft.
